(19) United States
(12) Patent Application Publication
(10) Pub. No.: US 2003/0053620 A1
(43) Pub. Date: Mar. 20, 2003

(54) Detachable conference telephone

(75) Inventor: Tonny Chen, Chang-Hua (TW)

Correspondence Address: DOUGHERTY & TROXELL, 5205 LEESBURG PIKE, SUITE 1404, FALLS CHURCH, VA, 22041, US

(73) Assignee: E-Lead Electronic Co., Ltd.

(21) Appl. No.: 09/955,182

(22) Filed: Sep. 19, 2001

(51) Int. Cl. H04M 1/00

(52) U.S. Cl. 379/447

(57) ABSTRACT

An improved detachable conference telephone and particularly a structure allowing microphone seats to detach and separate from the conference telephone main body. The structure mainly includes a conference telephone main body to couple with a plurality of microphone seats linking by wire reels. When using in conferences, users may detach the microphone seats from the main body and move the microphone seats closely to input audio voice so that poor audio transmission resulting from distant conference telephone may be prevented from happening.

### BACKGROUND OF THE INVENTION

1. Field of the Invention

The invention relates to a detachable conference telephone and particularly a conference telephone adaptable for use in different sizes of conferences with adjustable distances between microphones of the conference telephone and participants to prevent poor audio transmission resulting from distant microphones.

2. Description of the Prior Art

The rapid developments of business franchises, chain stores, and enterprise groups in recent years have greatly stretched the distances among the branch offices and subsidiaries. Communications among the business units scattered at different locations has become a huge challenge. For instance, to gather people from various remote branches and offices to the headquarter for meetings is time consuming and costly. The effect is dubious. To overcome the problems of conducting meetings for remote locations, conference telephone 9 (as shown in FIG. 1) has been developed and introduced. Using this facility to connect telephone lines, people at remote locations or offices can participate meetings or conferences without physically going to the head office. This type of conference generally has a conference telephone 9 located at the center of a conference table. The conference telephone 9 has a plurality of microphones 91, 92 and 93 to receive the speaking voices of the participants. While such a facility may resolve some of the problems set forth above, it often happens that the conference telephone 9 cannot receive the speaking voice properly because of the microphones are located at a distance from the speakers. Participants often have to repeat the speaking or raise the voices, or try to get closer to the microphones 91, 92, 93 to get their voices heard and received. As a result, the proceeding and effectiveness of the meeting is severely compromised or impaired.

As the distance between the participants and microphones is the main factor that cause undesirable telephone receiving, to use detachable microphones so that participants may speak to the microphone closely will resolve the problems incurred to the conventional conference telephones.

### SUMMARY OF THE INVENTION

The primary object of the present invention is to provide a detachable conference telephone that mainly employs extension lines to allow microphones detached from the conference telephone main body so that meeting participants can speak to the microphones closely to achieve a better conversation and communication effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional conference telephone.

FIG. 2 is a perspective view of an embodiment of the invention.

FIG. 3 is an exploded view of a wire winding means of the invention.

FIG. 4 is a left side view of a wire winding means of the invention, at a releasing state.

FIG. 5 is a right side view of a wire winding means of the invention, at a releasing state.

FIG. 6 is a left side view of a wire winding means of the invention, at a withdrawing state.

FIG. 7 is a right side view of a wire winding means of the invention, at a withdrawing state.

FIG. 8 is a schematic view of the invention, with a coil wire.

FIG. 9 is a fragmentary sectional view of a microphone seat coupling with the housing chamber.

FIG. 10 is another fragmentary sectional view of a microphone seat coupling with the housing chamber.

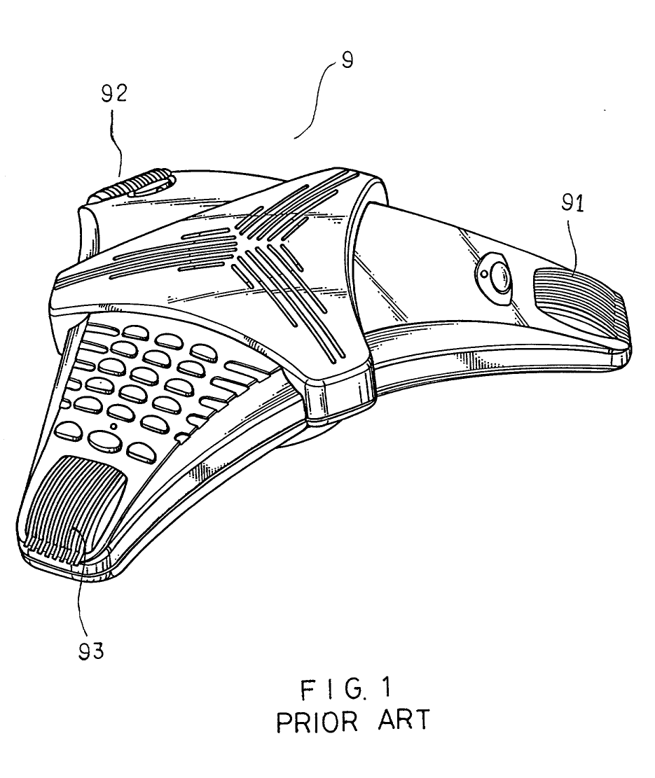

### DESCRIPTION OF THE PREFERRED EMBODIMENTS

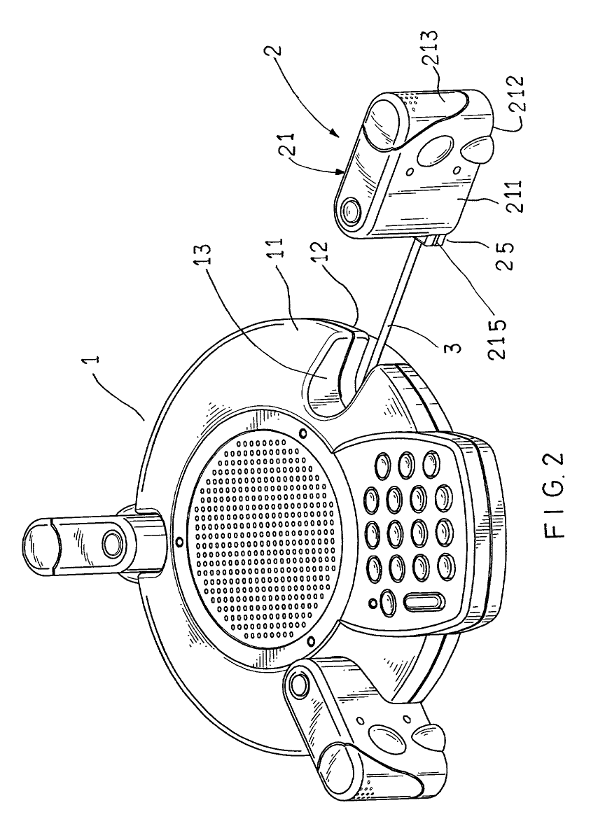

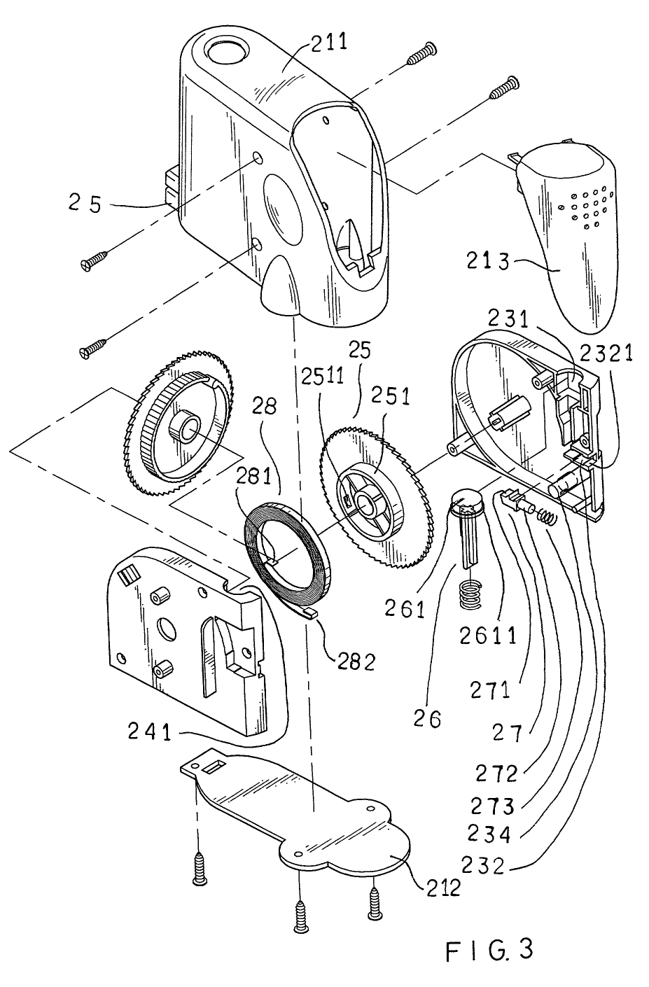

Referring to FIG. 2, the invention mainly includes a conference telephone main body 1 to couple with at least one microphone seat 2. The main body 1 has an interior space for housing required circuits and at least one housing chamber 13 formed on the peripheral rim to hold and anchor the matching microphone seat 2. Each microphone seat 2 is linked to the main body 1 through a wire reel 3 such that the microphone seat 2 may be detached and removed from the main body 1 to allow people at a distance from the main body speaking closely to the microphone seat 2 to get a better audio transmission quality.

The conference telephone main body 1 includes an upper casing 11 and a lower casing 12, and houses required circuits therein. As mentioned before, the main body 1 further has at least one housing chamber 13 formed on the peripheral rim to hold and anchor the matching microphone seat 2. Each microphone seat 2 is linked to the main body 1 by a wire reel 3.

In order to facilitate the releasing and withdrawing operations of the wire reel 3, a wire winding means is provided in the microphone seat 2 and housed in an outer casing 21 of the microphone seat (the outer casing 21 consists of a shell 211, a matching bottom cap 212 and a side cap 213). The wire winding means consists of a left casing 24, a right casing 23, a teethed disk 25, a push rod 26, a latch bar 27 and a spiral spring 28. Details will be elaborated as follows.

The left and right casing 24 and 23 may be coupled to form a completed casing for housing other components. At the upper rims of the left and right casing 24 and 23, there are rod troughs 231 and 241 which may be coupled to house the push rod 26. There is a transverse latch groove 232 located at the bottom ends of the rod troughs 231 and 241 for holding the latch bar 27.

The teethed disk 25 has a selected diameter, a plurality of teeth 253 formed on the peripheral rim thereof, and a torsional ring 251 located on one side for holding the spiral spring 28. The torsional ring 251 has a notch 2511 for anchoring one end 281 of the spiral spring 28.

The push rod 26 has a push button 261 located at the top end. The push button 261 has a button rim 2611 at a lower side which is slightly larger than the rod trough. The bottom end of the push rod may be pressed downwards against a sloped section of the latch bar 27 for moving the latch bar 27 rearwards.

The latch bar 27 has a sloped section 271 formed on an upper side of a block element to match the bottom end of the push rod 26, and an extended section 272 located at one end which is slightly smaller than the block element and an end rim 2321 of the latch groove 232. The extended section 272 couples with a spring 273 to allow the latch bar 27 engaging with the teethed disk 25 under normal conditions.

The spiral spring 28 is mounted on one side of the teethed disk 25, and has one end 281 anchoring to the notch 2511 of the torsional ring 251 and another end anchoring to a strut 234 located on the side wall of either the left or right casing.

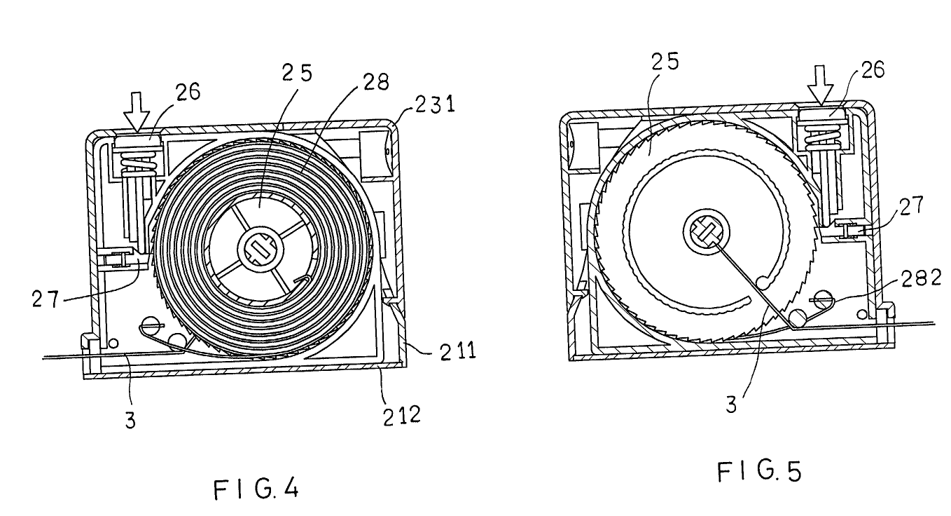

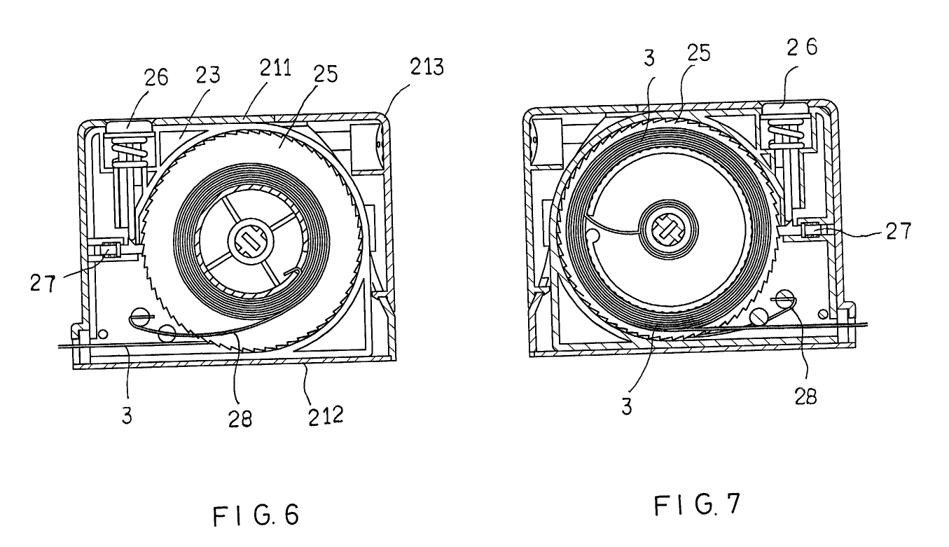

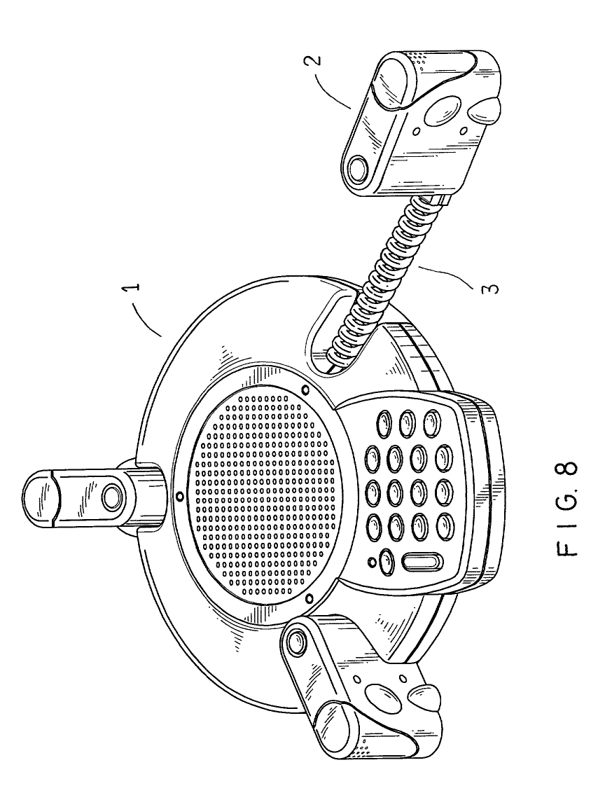

By means of the construction set forth above, when in use in a meeting or conference (referring to FIGS. 4 and 5), press directly the push rod 26 to urge the sloped section 271 of the latch bar 27, the latch bar 27 will be retreated rearwards, and the teethed disk 25 will be disengaged and freed from constraint. As a result, the microphone seat 2 may be moved out for use. In the mean time, the spiral spring 28 will be wound and contracted. After the microphone seat 2 being moved to a location desired, users may release the push rod 26 so that the latch bar 27 will engage to the teethed disk 25 again. Thus the detachment between the microphone seat 2 and the conference telephone main body 1 is completed (as shown in FIGS. 6 and 7). On the other hand, when users want the microphone seat 2 withdrawn, press the push rod 26 downwards and maintain the downward condition to allow the latch bar 27 retreated, the spiral spring 28 which already has torsional force will withdraw the wire reel 3 and the microphone seat 2. Thus the invention can overcome the problems of the conventional conference telephones. While the microphone seat 2 of the invention provides a wire winding means to enhance the releasing and withdrawing effect for the wire reel 3, it does not means that the detachment function and operations between the microphones and conference telephone solely depend on the wire winding means. FIG. 8 shows an embodiment in which the wire reel 3 is formed in a coil 30 to shorten the linear distance of the phone line and to extend the length when in use. Nevertheless, the wire reel 3 has a smaller size after winding and may be housed in housing chamber 13 along with the microphone seat 2, and also may facilitate wire releasing and withdrawing operations.

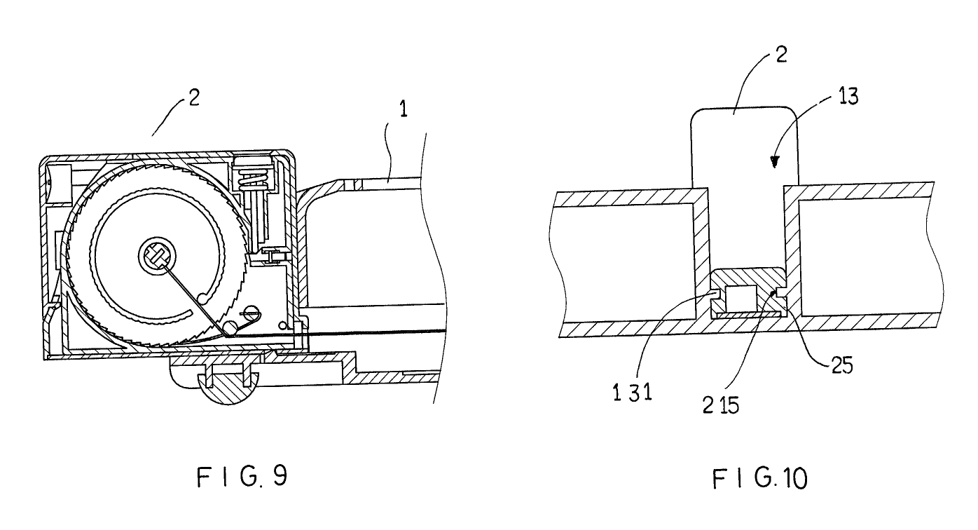

Furthermore, in order to enhance the latching and positioning of the microphone seat 2 in the housing chamber 13 of the conference telephone main body 1, a pair of opposing bulged ribs 131 may be formed on two side walls of the housing chamber to match and wedge in two transverse slots 215 formed on two lateral sides of the microphone seat 2 where an opening 214 is formed for the wire reel 3 to move in or out (as shown in FIGS. 9 and 10). Such a structure allows the microphone seat 2 nestling in the housing chamber 13 securely.

In summary, the invention provides a simple structure and allows the microphone seats be detached and moved closely to users when necessary so that conference telephone conversation can be proceeded with better quality.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. A detachable conference telephone, comprising:
a conference telephone main body having at least one housing chamber formed on the peripheral rim thereof; and
at least one microphone seat movably housed in the housing chamber and being detachably linked to the main body through a wire reel.

2. The detachable conference telephone of claim 1, wherein the wire reel is a wire means winding in an annular fashion.

3. The detachable conference telephone of claim 1, wherein the microphone seat has a wire winding means which consists of a left casing, a right casing, a teethed disk, a push rod, a latch bar and a spiral spring, and wire releasing and withdrawing is controllable by pressing the push rod.

4. The detachable conference telephone of claim 1, wherein the housing chamber of the conference telephone main body has a pair of opposing transverse slots formed on two lateral sides thereof, the microphone seat having two opposing bulged ribs located on two sides of an wire reel opening for matching and wedging in the transverse slots to nestle and position the microphone seat in the housing chamber.
